(19) United States
(12) Patent Application Publication
(10) Pub. No.: US 2011/0091680 A1
(43) Pub. Date: Apr. 21, 2011

(54) Molded Armature for Decorating

(75) Inventors: Nancy A. Zwiers, Long Beach, CA (US); Robin K. Smith, Long Beach, CA (US); Liliane Davidson, Studio City, CA (US)

(73) Assignee: Funosophy, Inc., Long Beach, CA (US)

(21) Appl. No.: 12/582,625

(22) Filed: Oct. 20, 2009

(51) Int. Cl. B32B 3/06

(52) U.S. Cl. 428/99

(57) ABSTRACT

The components of the system include a set of armatures and retention mechanisms that enable the construction of projects using beads where the beads are retained on the armature by the retention mechanism, but the beads can be removed without the use of tools or excessive force. This set of components provides a system to be used as a toy or craft project. The beads can be removed, replaced and reorganized to change the design and provide a high level of re-usability and playability for children and in crafting.

### TECHNICAL FIELD

Embodiments of the present invention relate to toys and crafts involving the use of beads. Specifically, the embodiments of the invention relate to an armature and a retention mechanism for use in crafts and toys using beads.

### BACKGROUND

Beads are commonly used in crafts and come in all shapes, sizes and varieties. Beads are threaded over wires and strings in craft projects. Beads serve as a decorative element in these projects and are selected to fit the aesthetic needs of the overall project. The wires and strings onto which the beads are threaded in these projects are small diameter materials that are threaded through the center of the beads. The beads are annular structures with a variety of shapes and materials. Once a set of beads has been placed on the wire or string, the ends are tied or closed off to maintain the position of the beads on the crafted item.

For example, if the beads are utilized with an underlying wire, the wire may be looped or similarly closed off at the ends so that the wire forms a structure at the terminus that is larger than the opening of the interior channel defined by bead. This closing structure prevents the beads from coming off of the wire and is difficult for someone without tools to undo.

Similarly, with beads that are threaded over a string, the ends of the string are tied off or knotted creating a structure that is larger than the opening defined by the bead. To undo the design, the user must untie or cut off the knot or tie. As a result, the beads used in these projects are fixed and cannot be easily removed. This is often an essential feature of these crafting projects, because it is undesirable that a design using beads, such as a piece of jewelry or a similar item crafted using beads, to come apart while in use.

### BRIEF DESCRIPTION OF THE DRAWINGS

Embodiments of the invention are illustrated by way of example and not by way of limitation and the figures of the accompanying drawings in which like references indicate similar elements. It should be noted that different references to “an” or “one” embodiment in this disclosure are not necessarily to the same embodiment, and such references mean at least “one.”

FIG. 1A is a diagram of one embodiment of a structure with two armatures.

FIG. 1B is a diagram of one embodiment of the structure covered with decorative beads.

FIG. 2 is a diagram of one embodiment of a retention mechanism.

FIG. 3A is a diagram of one embodiment of an alternate structure with multiple armatures and a coupling mechanism.

FIG. 3B is a diagram of one embodiment of the alternate structure with decorative beads.

FIG. 4A is a diagram of one embodiment of an alternate structure with a butterfly shape.

FIG. 4B is a diagram of one embodiment of the alternate structure partially covered with decorative beads.

FIG. 5A is a diagram of one embodiment of an alternate retention mechanism.

FIG. 5B is a diagram of one embodiment of an alternate retention mechanism.

FIG. 5C is a diagram of one embodiment of an end view of an alternate retention mechanism.

FIG. 5D is a diagram of one embodiment of an alternate retention mechanism.

FIG. 6A is a diagram of one embodiment of a locking mechanism.

FIG. 6B is a diagram of one embodiment of an alternate locking mechanism.

FIG. 6C is a diagram of one embodiment of an alternate locking mechanism.

FIG. 7A is a diagram of one embodiment of a cross-section of a locking mechanism in a locked state.

FIG. 7B is a diagram of one embodiment of a cross-section of a locking mechanism in an unlocked state.

FIG. 8 is a diagram of one embodiment of a structure with a locking mechanism.

### DETAILED DESCRIPTION

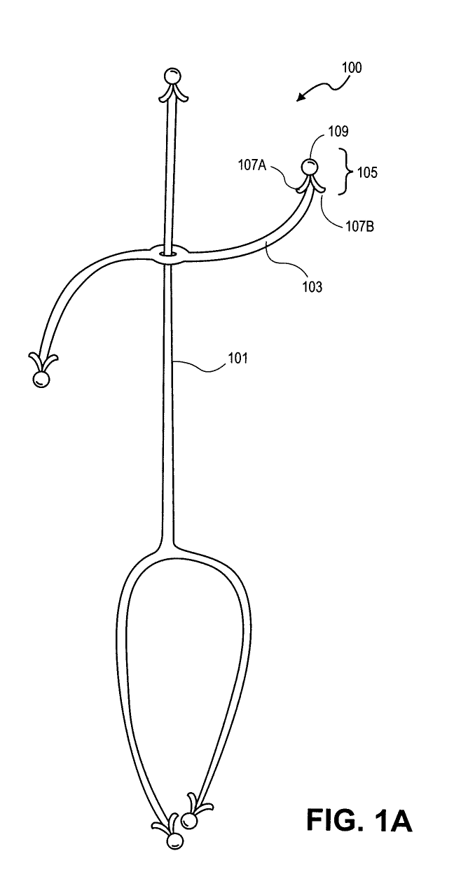

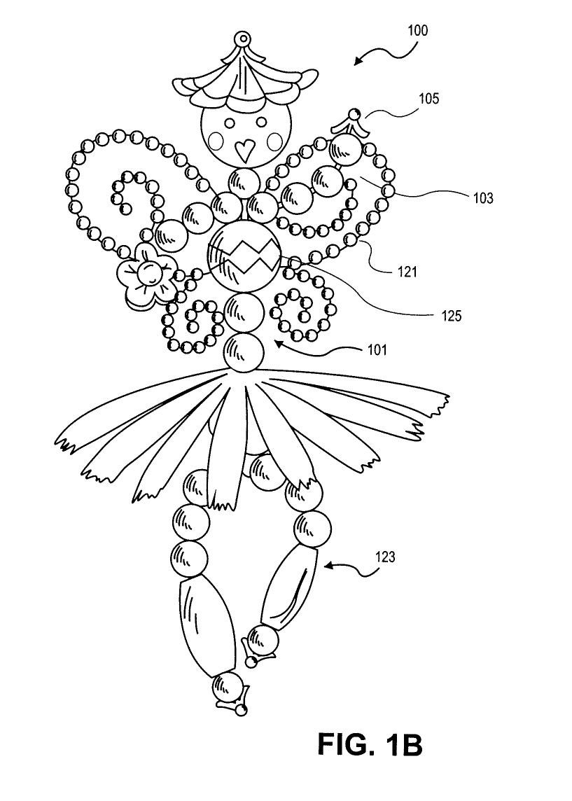

FIG. 1A is a diagram of one embodiment of a structure with two armatures. The structure 100 can have any shape or number of constituent components including armatures 101, 103. The structure 100 can be shaped to resemble any structure or object. For example, the structure can be designed to resemble a skeleton of the human form or a building. In one embodiment, the structure 100 is a single integral piece. In another embodiment, the structure is composed of multiple armatures 101, 103 that are coupled together using any type of coupling mechanism to form the structure 100. Each of the armatures 101, 103 in a structure 100 can include a retention mechanism 105. Any number of retention mechanisms 105 can be included in any individual armature 101, 103 or an overall structure 100 defined by a set of armatures. A ‘set,’ as used herein, refers to any positive whole number of items including one item.

Each armature 101, 103 can be formed from any semi-rigid material including any type of plastic, resin, rubber, sheathed wire or similar artificial or natural material. The armature 101 can have any size or shape that is suitable for threading beads. The diameter of the armature 101 can range from one millimeter to one centimeter or more. The armature 101 can have a cylindrical cross-section, a smooth surface or can have any variance in diameter with any number of squared or angular exterior surfaces. The armature 101 can be formed integrally with the retention mechanism 105 or they can be separately attached to one another through a form-fit, snap-fit, adhesive or similar attachment mechanism.

The armature 101 can be formed through a molding process, extrusion process or through a similar manufacturing process. The flexibility of the armature 101 largely depends on the type of materials chosen for the design of the structure 100. The armature 101 can have a very rigid structure to maintain the intended design or can have a relatively flexible structure to enable a range of movement in different aspects of the armature. For example, the structure 100 is designed to resemble a human form and the arms and legs (armatures 101,103) have a certain flexibility to enable a user to easily pose and thread each armature 101, 103.

A retention mechanism 105 can include a set of arms 107A, 107B and a protective structure 109. The arms 107A, 107B are compression elements that allow the bead to be threaded over the retention mechanism 105 and onto the armature 103. The arms 107A, 107B can be hingedly attached or integrally formed as a hinge with the armature 103. When a bead is slid over the retention mechanism 105, the arms 107A, 107B compress toward the armature 103 and allow passage of the bead in either direction. However, a threshold amount of force is required to move the arms 107A, 107B requiring that a user apply the threshold force to the bead to move it across the retention mechanism 105. When the threshold force is not applied by the user, incidental forces acting on a bead are not sufficient to enable the bead to cross the retention mechanism 105.

The protective structure 109 can be a rounded end, soft material or similar structure that prevents the armature 101, 103 from being a safety hazard. The protective structure 109 can have any shape or be formed from any material. The protective structure 109 can have a decorative function. The dimensions of the protective structure 109 are selected to ensure that it does not inhibit movement of a bead during threading.

FIG. 1B is a diagram of one embodiment of the structure covered with decorative beads. The structure 100 includes the armatures 101, 103 that are covered with a set of decorative beads 121, 125. These beads 121, 125 can have any shape, size, color or similar decorative characteristics. The beads 121, 125 can be plastic, metal, resin, rubber, wood or any other similar natural or artificial material. The beads 121, 125 can be transparent or opaque and can have any number of decorative features imprinted, embossed, painted or similarly attached to them. Some beads 121, 125 can include more elaborate structures that are attached to them such as the wing structure 121 shown FIG. 1B. This wing structure 121 is attached to the armature 101 through an annular element or is similarly attached to a bead 125. A ‘bead,’ as referred to herein is any structure that includes at least one annular element or similar interior channel for threading over an armature. The diameter of the interior channel of each of the beads is greater than that of the armature, but smaller than the extended arms of the retention mechanism 105. This enables the retention mechanism 105 to hold the beads 121, 125 on the armature 101, 103 unless a sufficient force is applied to them to collapse the arms of the retention mechanism 105. This set of features defines a relationship between the beads 121, 125 and the retention mechanism 105 that enables a user to reliably add and remove beads to alter a design making the structure suitable for use as a toy or as part of a craft project where a design can be temporarily fixed and not require tools for adding or removing beads or holding them in place on the structure 100.

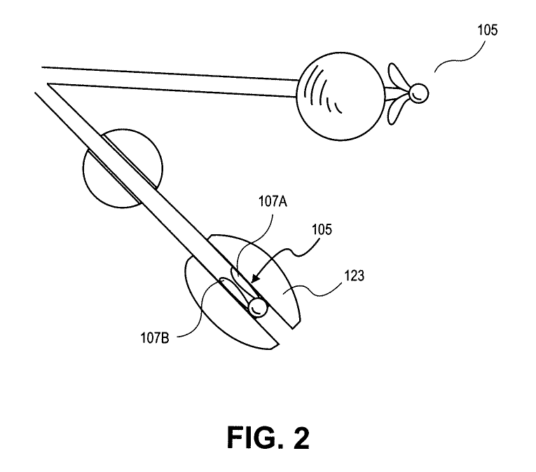

FIG. 2 is a diagram of one embodiment of a retention mechanism. In this embodiment, the retention mechanism 205 is shown while the bead 223 is crossing the retention mechanism 205. The arms of the retention mechanism 207A, 207B are collapsed against the armature 203 such that the overall diameter of the combined armature 203 and arms 207A, 207B and their retention mechanism 205 fits within the diameter of the channel defined by the bead 223. The size, dimensions and number of arms 207A, 207B can be varied with the overall design of the structure including the type beads such that the dimensions of the retention mechanisms complement one another where the collapsed set of arms 207A, 207B has a diameter that is slightly smaller than that of the channel of the beads 223 to be used and that the arms 207A, 207B when not compressed, form a structure that is larger than the channel diameter. The structure of the arms 207A, 207B is flexible but has a resilient memory such that the arms revert to a state of expansion when sufficient force is not applied to compress them.

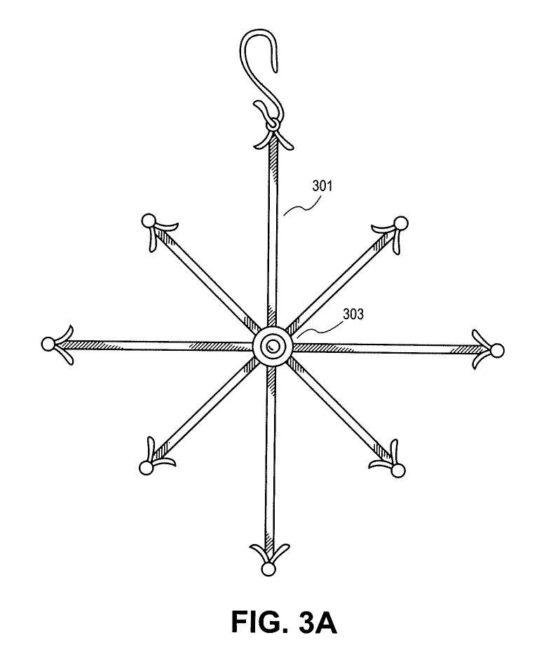

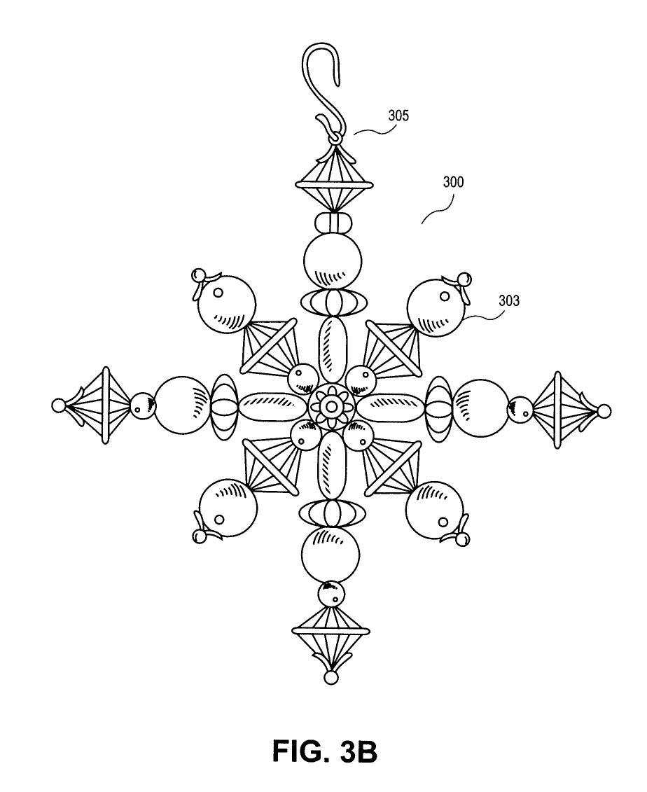

FIG. 3A is a diagram of one embodiment of an alternate structure with multiple armatures and a coupling mechanism. This is an alternate embodiment of the structure with a set of armatures 301 in a star pattern. In this embodiment, the armatures 301 are connected through a coupling mechanism 303. The coupling mechanism 303 can be designed to interact with any number of armatures 301 with any type of connection mechanism. In one embodiment, in a relationship between the armatures 301 and the coupling mechanism 303 can be a male/female plug relationship with either the armature or coupling mechanism having the male or female connector. The coupling mechanism 303 can also utilize a snap-fit, form-fit or similar mechanical coupling mechanism to attach any number of armatures. Any combination and number of coupling mechanisms 303 can be used to form any size or shape of a structure using any number of armatures 301.

FIG. 3B is a diagram of one embodiment of the alternate structure with decorative beads. In this embodiment, the star-shaped pattern is covered with a set of beads 307 to form a completed design. Any shape, pattern or combination of beads can be utilized. In some embodiments, additional mechanisms or functional elements such as a hook 305 can be included in a structure 300. These additional mechanisms and functional elements can be integrally formed or attached to the armatures or coupling mechanisms. This enables the completed structure 300 to be used as a decorative element such as an ornament or similar decoration.

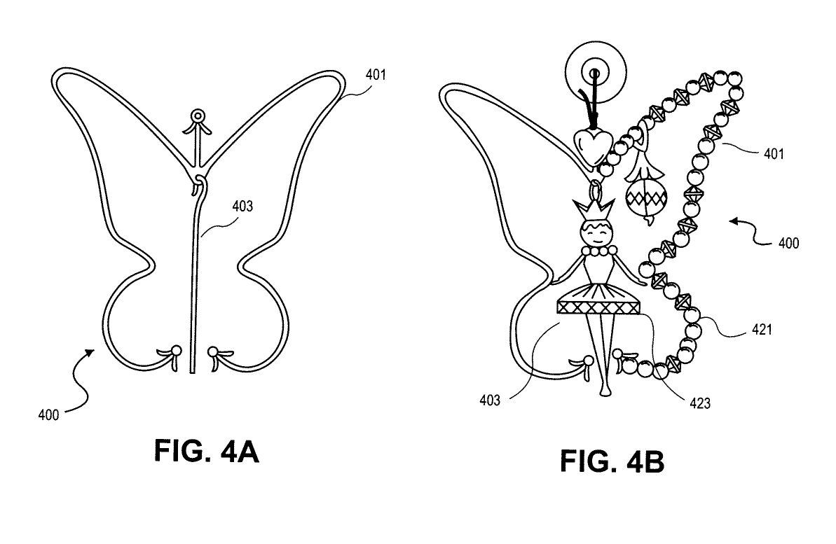

FIG. 4A is a diagram of one embodiment of an alternate structure with a butterfly shape. In this embodiment, the structure 400 includes two interlocking armatures 401, 403. This structure 400 forms a butterfly shape. Any shape of animate or inanimate object can be created using the interlocking sets of armatures and coupling devices. FIG. 4B is a diagram of one embodiment of the alternate structure partially covered with decorative beads. The partially decorated structure 400 includes a set of beads that have been placed on the armature 401 and the armature 403 including a combination of small beads 421 and the large doll bead 423. This embodiment, in combination with the previously described embodiments, gives an illustration of the range of structures that can be created using the system. One of ordinary skill in the art would understand that the structures illustrated herein and described herein are provided for sake of example and not limitation. Any number and combination of armatures can be utilized and any number and combination of retention mechanisms can be utilized to create any shape or structure suitable for decorative purposes or for use as a toy.

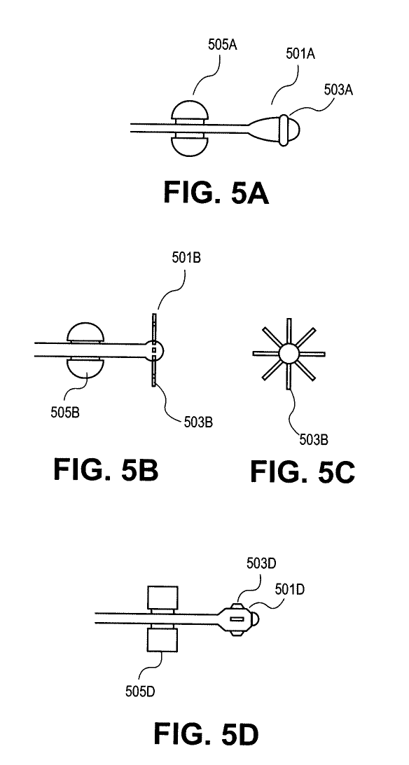

FIG. 5A is one embodiment of an alternate retention mechanism. In one embodiment, the retention mechanism 501A includes a compression element 503A. In this embodiment, the compression element 503A is a ring structure attached to the retention mechanism 501A. The ring structure may be formed from any compressible material such as a rubber, foam or similar material. The bead 505A can cross the retention mechanism 501A when sufficient force is applied to compress the compression element 503A.

FIG. 5B is a diagram of an alternate retention mechanism. In this embodiment, the retention mechanism 501B includes a compression element 503B that is formed from a set of bristles or similar structures. The bristles can be formed from any natural or artificial material. The bead 505B can cross the retention mechanism 501B when sufficient force is applied to bend the bristles 503B such that they fit within the channel of the bead 505B. FIG. 5C is a diagram of an end view of an alternate retention mechanism. The array of bristles 503B or similar structures can have any spacing or number and any length sufficient to define a diameter that is larger than that of the bead.

FIG. 5D is a diagram of one embodiment of an alternate retention mechanism. In one embodiment, the retention mechanism 501D may include a set of moveable parts such as a set of leaves 503D that when compressed, allow a bead 505D to cross the retention mechanism 501D. These leaves 503D can be spring loaded or similarly biased to an extended position and can be moved to a compressed position when sufficient force is applied to a bead 505D to enable it to cross over the retention mechanism 501D. The leaves 503D can have any shape suitable for enabling the bead 505D to cross the retention mechanism 501D when the appropriate force is applied such as a shape with angled, beveled or rounded edges.

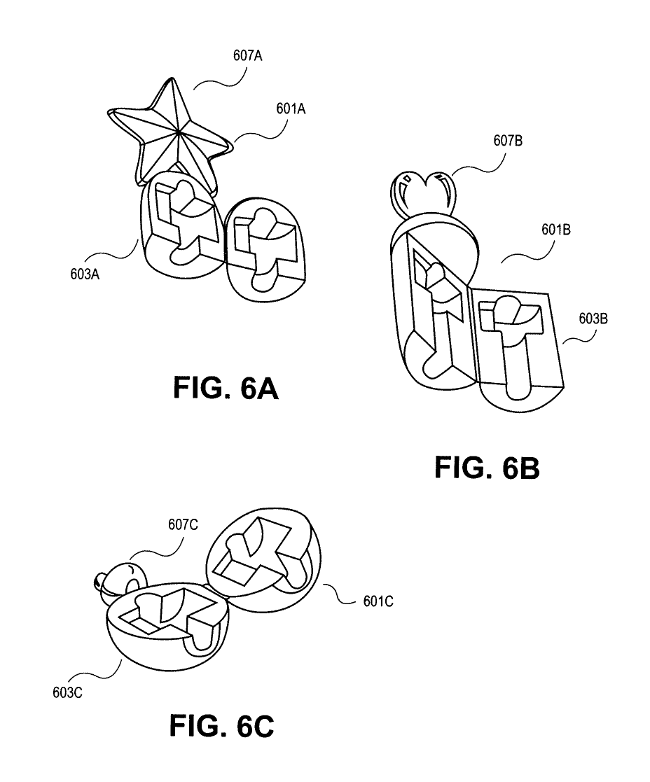

FIGS. 6A-6B are diagrams of a variety of locking mechanisms. In one embodiment, the locking mechanisms 601A-601C include a cap 603A-603C defining locking chambers 605A-605C. The locking mechanisms 601A-601C can have any shape, dimensions or decorative features 607A-607C. In one embodiment, the caps 603A-603C open to reveal the locking chambers 605A-605C. The caps 603A-603C can be divided into halves that are hingedly or similarly connected. The caps 603A-603C define a locking chamber 605A-605C that locks a retention mechanism placed within the locking mechanism 601A-601C to add an additional level of security to the design when completed as well as provide additional decorative elements. The locking chamber 605A-605C can be a form-fit with the retention mechanism or similarly inter-lock in the retention mechanisms.

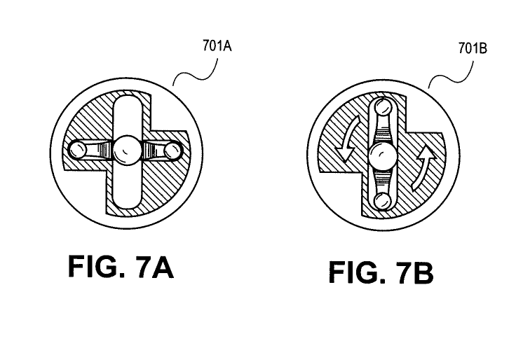

FIGS. 7A and 7B are diagrams of cross-sections of alternate locking mechanisms. In this embodiment, the locking mechanisms 701A, 701B define an opening into which a retention mechanism is inserted. The compression mechanisms are aligned with the opening to allow insertion of the retention mechanisms. The retention mechanisms are then rotated relative to the opening such that the compression mechanisms no longer align with the opening. The misalignment locks the retention mechanisms with the locking mechanisms 701A, 701B. In this manner, the locking mechanisms 701A, 701B can be utilized to secure a completed design by protecting the retention mechanism and to provide an additional decorative element to a structural design.

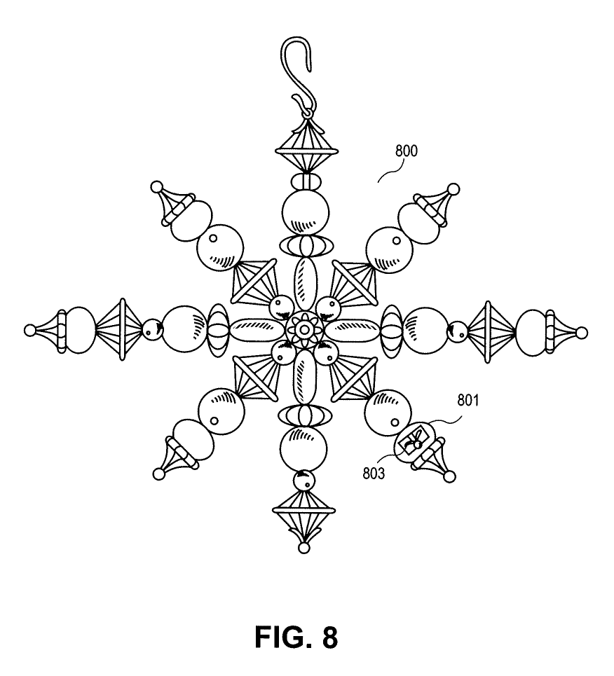

FIG. 8 is a diagram of one embodiment of a structure with a locking mechanism. The locking mechanism 801 can be used to secure the end of any armature in a structure 800. Any number of locking mechanisms 801 can be utilized in a structure up to the number of retention mechanisms in the structure. The locking mechanism 801 can be locked and unlocked without the use of tools and can be re-used any number of times. While locked the locking mechanism 801 prevents the movement of the retention mechanism 803 that is disposed within the locking mechanism 801. This prevents the removal of beads over the locked retention mechanism. The locking mechanism 801 can be unlocked through the rotation of the locking mechanism or through a similar unlocking or releasing process. The locking mechanism 801 can be removed from a structure when unlocked and the retention mechanism continues to provide a lower level of security or fixation for the design as described above that requires a user to apply a threshold amount of force to remove beads.

The described locking mechanisms are provided by way of example. One skilled in the art would understand that other similar locking mechanisms are within the scope of the invention. The principle, structures and features of these locking mechanisms can be used in combination with any shape or size of locking mechanism such that they can be complementary to any type of retention mechanism.

In the foregoing specification, the invention has been described with references to specific embodiments. It will, however, be evident that various modifications and changes can be made thereto without departing from the broader spirit and scope that is set forth in the appended claims. The specification and drawings are accordingly to be regarded in illustrative rather than a restrictive sense.

1. An apparatus comprising:
an armature having a semi-rigid shape to receive a plurality of annular structures; and
a retention mechanism coupled to the armature, the retention mechanism to hold the plurality of annular structures on the armature and to control addition and removal of the plurality of annular structures while coupled to the armature.

2. The apparatus of claim 1, wherein the armature is a molded or extruded structure.

3. The apparatus of claim 1, further comprising:
a coupling mechanism to removably couple the armature to another armature.

4. The apparatus of claim 1, wherein the retention mechanism includes a plurality of compression elements that compress to enable passage of an annular structure over the armature.

5. The apparatus of claim 4, wherein the plurality of compression elements include any one of a barb, leaf, bristle or ring.

6. The apparatus of claim 1, further comprising:
a locking mechanism removeably coupled to the retention mechanism to provide an additional level of security in fixing a design.

7. The apparatus of claim 1, wherein the armature has dimensions to allow threading of the plurality of annular structures over the armature to occlude the armature.

8. An apparatus comprising:
an armature to receive a plurality of decorative annular structures, the armature formed from a mold to define a discrete shape; and
a retention mechanism coupled to the armature, the retention mechanism to removably hold the plurality of annular structures on the armature.

9. The apparatus of claim 8, wherein the retention mechanism controls addition and removal of the plurality of decorative annular structures while coupled to the armature.

10. The apparatus of claim 8, further comprising:
a coupling mechanism to removably couple the armature to another armature.

11. The apparatus of claim 9, wherein the retention mechanism includes a plurality of compression elements that compress to enable passage of an annular structure over the armature.

12. The apparatus of claim 11, wherein the plurality of compression elements include any one of a barb, leaf, bristle or ring.

13. The apparatus of claim 11, wherein the retention mechanism is integrally formed with the armature.

14. The apparatus of claim 8, further comprising:
a locking mechanism removeably coupled to the retention mechanism to provide an additional level of security in fixing a design

15. The apparatus of claim 8, wherein the armature has dimensions to allow threading of the plurality of annular structures over the armature to occlude the armature.

16. An apparatus comprising:
a means for receiving a plurality of decorations having an annular element, the means for receiving the plurality of decorations having a semi-rigid shape; and
a means for retaining the decorations coupled to the means for receiving the plurality of decorations, the means for retaining to hold the plurality of decorations on the means for receiving the plurality of decorations and to control addition and removal of the plurality of decorations while coupled to the armature.

17. The apparatus of claim 16, wherein the means for receiving the plurality of decorations is a molded or extruded structure.

18. The apparatus of claim 16, further comprising:
a means for coupling to removably couple the means for receiving the plurality of decorations to an armature.

19. The apparatus of claim 16, wherein the means for retaining the decorations includes a plurality of compression elements that compress to enable passage of the annular element over the armature.

20. The apparatus of claim 19, wherein the plurality of compression elements include any one of a barb, leaf, bristle or ring.
